(19) United States
(12) Patent Application Publication
(10) Pub. No.: US 2020/0250749 A1
(43) Pub. Date: Aug. 6, 2020

(54) BUSINESS PERFORMANCE FORECAST MANAGEMENT SYSTEM AND METHOD

(71) Applicant: Hironobu KATOH, Meguro-ku, Tokyo (JP)

(72) Inventor: Hironobu KATOH, Meguro-ku, Tokyo (JP)

(21) Appl. No.: 16/488,519

(22) PCT Filed: Oct. 24, 2017
(86) PCT No.: PCT/JP2017/038367

§ 371 Date: Aug. 23, 2019

(51) Int. Cl. G06Q 40/04; G06Q 30/02; G06Q 10/06

(52) U.S. Cl. CPC G06Q 40/04; G06Q 10/06375; G06Q 30/0201

(57) ABSTRACT

[Problem to be Solved] Provided is a business performance forecast management system and method which can make it easy to share and manage business performance forecasts of an enterprise by a plurality of users, and enable a stock investment recommendation that respects business performance forecasts of each user, including retail and small scale investors.

[Solution] Each of client terminals transmits, to a server, a respective user forecast value related to business performance of an enterprise. The server stores, in a memory, the user forecast value received from each of the client terminals, calculates a market forecast based on the plurality of the stored user forecast values, calculates a deviation value of the user forecast value transmitted from at least one of the client terminals with respect to the market forecast, and transmits an alert to the at least one client terminal when the deviation value is equal to or greater than a predetermined value.

### TECHNICAL FIELD

The present technology relates to a system and a method that manage business performance forecasts of enterprises.

### BACKGROUND ART

A method for recommending stocks (issue) purchasing and selling of an enterprise is mainly considered to be as follows.

(1) To determine based on stocks' market prices.

For example, a sell recommendation is made when an absolute stock price is too high, and a buy recommendation is made when the absolute stock price is too low. In addition, a sell recommendation is made when an increase in a stock price during a certain period is too large, and a buy recommendation is made when a decrease in the stock price is too large.

(2) To determine based on market capitalization.

For example, a buy recommendation is made when a market capitalization is lower than those of similar enterprises. In addition, a buy recommendation is made for small market capitalization stocks with large upside in absolute value. For a large cap stock having a large absolute market capitalization, a sell recommendation is made when there is little room for increase.

(3) To determine based on forecasts made by analysts of securities companies or research companies.

Whether a stock price is high or low is determined based on business performance forecasts of analysts. For example, a buy recommendation is made according to an analyst in charge of an electrical appliances sector when a stock price or market capitalization of company A is low with respect to the business performance of company A.

Surprises are forecasted based on a business performance forecast of a specific analyst. For example, a specific analyst B forecasts that business performance of company A exceeds consensus of an unspecified number of analysts collected by Nikkei QUICK Inc., Bloomberg, securities companies, research companies, and the like, and makes a buy recommendation.

(4) Basket Recommendation

An unspecified number of issues that are included in a specific theme or sector are recommended. For example, since artificial intelligence (AI) will be developed in the future, it is recommended to purchase stocks of 30 AI-related companies.

In addition, an unspecified number of issues are recommended, which are extracted based on certain indices or factors, such as a dividend payout ratio and a return on equity (ROE). For example, it is recommended to purchase issues having high dividend yields. However, determination is made based on forecasts of securities companies and research companies, or each listed company's plans or actual performance.

### CITATION LIST

### Patent Literature

Patent Literature 1: Japanese Patent Laid-Open No. 2007-264969

Patent Literature 2: Japanese Patent Laid-Open No. 2011-232954

### SUMMARY OF INVENTION

### Technical Problem

Stock prices are not determined by securities companies or research companies, but determined by supply and demand of stock market participants. A system or method is desired, which makes recommendations according to views of each user based on the user's own business performance forecasts of the user who may be a stock market participant instead of being based on forecasts of securities companies, or research institutions or forecasts of third parties.

A system or method capable of collecting and analyzing business performance forecasts of a plurality of users is also desired.

Further, a system or method is desired, which makes recommendations based on an average and distribution of business performance forecasts of system's participants.

Further, a system or method is desired, which modifies recommendations according to changes in an average of business performance forecasts of system participants.

Further, a system or method is desired, which recommends whether to hold stocks long-term based on business performance forecasts rather than stock prices.

Further, a system or method is desired, which recommends whether a user should take action based on that user's past performance.

### Solution to Problem

The present technology relates to a business performance forecast management system configured to manage business performance forecast of an enterprise. The system includes: a server, which includes a processor and a memory; and a plurality of client terminals, which are capable of communicating with the server. Each of the client terminals is configured to transmit, to the server, a respective user forecast value related to business performance of the enterprise. The server is configured to store, in the memory, the user forecast value received from each of the client terminals, calculate a market forecast based on the plurality of the stored user forecast values, calculate a deviation value of the user forecast value transmitted from at least one of the client terminals with respect to the market forecast, and transmit an alert to the at least one client terminal when the deviation value is equal to or greater than a predetermined value.

### BRIEF DESCRIPTION OF DRAWINGS

FIG. 1 shows a business performance forecast management system according to an embodiment of the present technology.

FIG. 2 is a flowchart showing a business performance forecast management method according to the embodiment of the present technology.

### DESCRIPTION OF EMBODIMENTS

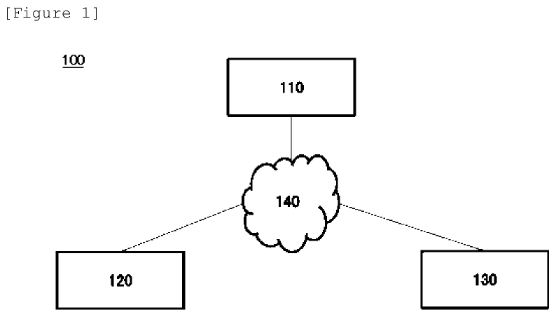

FIG. 1 shows a business performance forecast management system 100 according to an embodiment of the present technology.

The business performance forecast management system 100 includes a server 110 connected to the Internet 140, a client terminal 120, and a client terminal 130.

The server 110 is a computer having a function of communicating with the client terminal 120 and the client terminal 130 via the internet. The client terminal 120 is a computer, a tablet terminal, or a smartphone having a function of communicating with the server 110 via the internet, and the client terminal 130 is also the same. Client terminals are not limited to the client terminal 120 and the client terminal 130, and more client terminals can be connected.

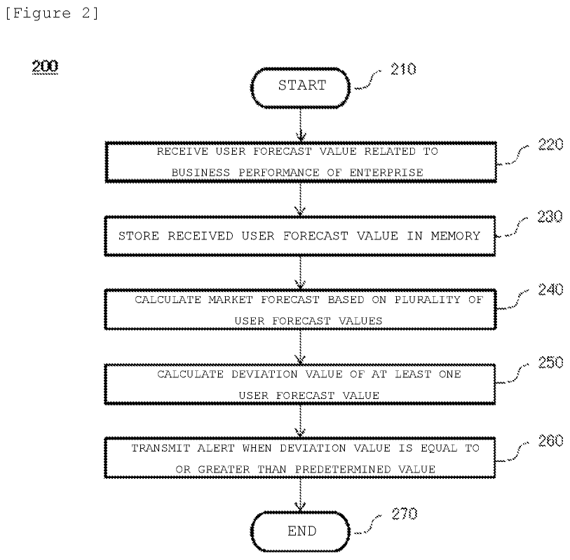

FIG. 2 shows a business performance forecast management method 200 according to the embodiment of the present technology.

In step 210, the business performance forecast management method 200 is started in the server 110. Next, in step 220, a user forecast value related to business performance of an enterprise is received. The user forecast value related to the business performance of the enterprise is input to the client terminal 120 by a user, and transmitted from the client terminal 120 to the server 110.

The user forecast value related to the business performance of the enterprise includes, for example, a forecast value related to a continuous profit of the enterprise. The forecast value related to the continuous profit of the enterprise includes a forecast value related to at least one factor including revenues, operating profit, earnings before tax, net profit, and earnings per share of the enterprise. The server 110 may calculate a forecast value based on one of a plurality of forecast values among the revenues, the operating profit, the earnings before tax, the net profit, and the earnings per share of the enterprise through weighting and averaging or calculate forecast values of other factors. The forecast value related to the continuous profit of the enterprise may be a factor specified in advance by the enterprise or by an industry to which the enterprise belongs.

Next, in step 230, the user forecast value received from the client terminal 120 is stored in a memory (not shown) in the server 110. The memory may be a magnetic storage device such as a hard disk drive (HDD) or a semiconductor storage device such as a solid state drive (SSD).

In step 220, the server 110 also receives other user forecast values related to the business performance of the enterprise from the client terminal 130 and other client terminals, and in step 230 the server 110 stores the other received user forecast values in the memory.

Next, in step 240, the plurality of user forecast values received from the client terminal 120, the client terminal 130, and the other client terminals and stored in the memory are used to calculate a market forecast related to the business performance of the enterprise. The market forecast calculated based on the plurality of user forecast values is represented by, for example, an average value and a standard deviation of the plurality of user forecast values. During calculation of the market forecast, a forecast value of a specific user may be included or excluded. In addition, the market forecast may be calculated or validated only when there is a certain number or more of user forecast values.

Next, in step 250, a deviation value of the user forecast value transmitted from at least one of the client terminals, for example the client terminal 120, with respect to the market forecast is calculated. The deviation value is, for example, a difference between the user forecast value and the average value.

Next, in step 260, when the deviation value is equal to or greater than a predetermined value, an alert is transmitted to the client terminal 120. The predetermined value may be one or two times of the standard deviation, or may be a predetermined ratio (for example, 10% or 15%) with respect to the average value. When there is a large change in one time business performance of an enterprise, for example, as for an enterprise whose annual operating profit is typically around 10 billion yen, in a case where an operating profit in the last year is 1 billion yen due to a one time factor, a business performance forecast of the next year may vary greatly. In such a case, normalization or adjustment may be made.

In step 260, the alert may be transmitted only when past performance of the user is equal to or greater than a certain level, for example, when a difference between a past user forecast value and an actual performance value of the business performance of the enterprise is within a predetermined range. The predetermined range includes, for example, a case where past forecast values of respective users with respect to the enterprise are ranked in an order of closeness to the actual performance value, and the user's forecast value is ranked at high position. In a case where there are forecast values and actual performance values of a plurality of years, more recent ranks may be weighted and averaged, or ranks in years when the business performance variation is larger may be weighted and averaged. The averaged ranks may be expressed in quartiles or quintiles.

In step 260, the alert may be transmitted only when confidence in the user forecast value is high.

The alert indicates that there is a certain amount of deviation between a user's forecast and the market's forecast related to the enterprise' business performance forecast of the enterprise. This suggests that the market could be surprised if the user's forecast is correct, and the user can expect the stock price to move significantly. The alert may be considered, for example, as a “securities to watch” or a “securities recommended to buy/sell (trade)”.

Next, in step 270, the business performance forecast management method 200 is ended.

In the above embodiment, the market forecast can be updated periodically or irregularly. For example, latest forecast values of all users who have made forecasts of a specific enterprise for a specific accounting period may be collected, and an average and a standard deviation of the forecast values of all the users excluding a forecast value of oneself may be calculated, and each user may be notified of whether a difference between an updated market forecast and the forecast of oneself becomes smaller or larger than previous calculation.

### INDUSTRIAL APPLICABILITY

The present technology can make it easy to share and manage business performance forecasts of an enterprise by a plurality of users, and enable a stock investment recommendation that respects business performance forecasts of each user, including retail investors and small scale investors. In addition, it is possible to grasp latest market forecasts without waiting for updates from analysts in securities brokers, research companies, and the like, which may take a long time to go through their internal processes. For example, the present invention can be applied to support those making business performance forecasts, such as retail investors or institutional investors, with their investment decisions. REFERENCE SIGNS LIST

100 Business performance forecast management system

110 Server

120, 130 Client terminal

1. A business performance forecast management system configured to manage a business performance forecast of an enterprise, the business performance forecast management system comprising:
a server, which includes a processor and a memory; and
a plurality of client terminals, which are capable of communicating with the server,
wherein each of the client terminals is configured to transmit, to the server, a respective user forecast value related to business performance of the enterprise, and
the server is configured to store, in the memory, the user forecast value received from each of the client terminals, calculate a market forecast based on a plurality of the stored user forecast values, calculate a deviation value of the user forecast value transmitted from at least one of the client terminals with respect to the market forecast, and transmit an alert to the at least one client terminal when the deviation value is equal to or greater than a predetermined value.

2. The business performance forecast management system according to claim 1, wherein the user forecast value includes a forecast value related to a continuous profit of the enterprise.

3. The business performance forecast management system according to claim 2, wherein the forecast value related to the continuous profit of the enterprise includes a forecast value related to at least one of revenues, operating profit, earnings before tax, net profit, and earnings per share of the enterprise.

4. The business performance forecast management system according to claim 3, wherein the user forecast value is calculated based on at least two of the revenues, the operating profit, the earnings before tax, the net profit, and the earnings per share of the enterprise.

5. The business performance forecast management system according to claim 1, wherein the market forecast includes an average value and a standard deviation of the plurality of the user forecast values.

6. The business performance forecast management system according to claim 5, wherein the deviation value is a difference between the user forecast value and an average value of the plurality of the user forecast values.

7. The business performance forecast management system according to claim 6, wherein the predetermined value is one or two times of the standard deviation.

8. The business performance forecast management system according to claim 1, wherein the transmitting of the alert to the at least one client terminal when the deviation value is equal to or greater than the predetermined value is performed only when past performance of the user is equal to or greater than a certain level.

9. The business performance forecast management system according to claim 8, wherein the past performance of the user forecast value being equal to or greater than the certain level means that a difference between a past user forecast value and an actual performance value of the business performance of the enterprise is within a predetermined range.

10. The business performance forecast management system according to claim 8, wherein the past performance of the user forecast value being equal to or greater than the certain level means that the user forecast value is ranked equal to or higher than a predetermined rank when differences between respective past user forecast values and an actual performance value of the business performance of the enterprise are ranked in an ascending order.

11. The business performance forecast management system according to claim 5, wherein the market forecast is updated periodically or irregularly.

12. The business performance forecast management system according to claim 1, wherein the alert is transmitted only when confidence in the user forecast value is high.

13. The business performance forecast management system according to claim 1, wherein the alert includes an indication of a “securities to watch” or a “securities recommended to buy/sell (trade)”.

14. A business performance forecast management method configured to manage a business performance forecast of an enterprise in a server including a processor and a memory, the server being capable of communicating with a plurality of client terminals,
the business performance forecast management method comprising:
receiving, from each of the client terminals, a respective user forecast value related to business performance of the enterprise;
storing, in the memory, the user forecast value received from each of the client terminals;
calculating a market forecast based on the plurality of the stored user forecast values;
calculating a deviation value of the user forecast value transmitted from at least one of the client terminals with respect to the market forecast; and
transmitting an alert to the at least one client terminal when the deviation value is equal to or greater than a predetermined value.

15. A computer-readable recording medium, comprising a program for:
receiving, by a server, a respective user forecast value related to business performance of an enterprise from each of the client terminals, the server including a processor and a memory, and being capable of communicating with a plurality of client terminals;
storing, in the memory, the user forecast value received from each of the client terminals;
calculating a market forecast based on the plurality of the stored user forecast values;
calculating a deviation value of the user forecast value transmitted from at least one of the client terminals with respect to the market forecast; and
transmitting an alert to the at least one client terminal when the deviation value is equal to or greater than a predetermined value.
